(19) United States
(12) Patent Application Publication
(10) Pub. No.: US 2009/0016953 A1
(43) Pub. Date: Jan. 15, 2009

(54) High-Temperature Air Braze Filler Materials And Processes For Preparing And Using Same

(76) Inventors: Kenneth Scott Weil, Richland, WA (US); John S. Hardy, Richland, WA (US); Jin Yong Kim, Richland, WA (US)

Correspondence Address: BATTELLE MEMORIAL INSTITUTE;ATTN: IP SERVICES, K1-53, P. O. BOX 999, RICHLAND, WA, 99352, US

(21) Appl. No.: 12/170,593

(22) Filed: Jul. 10, 2008

Related U.S. Application Data
(60) Provisional application No. 60/949,069, filed on Jul. 11, 2007.

(51) Int. Cl. C01D 1/02; C01G 57/00; B29B 9/00

(52) U.S. Cl. 423/593.1; 264/5

(57) ABSTRACT

High-temperature air braze filler materials composed of various ternary metal alloys are described. Noble metals (M) are added as a ternary constituent to a silver-copper oxide (Ag—CuOₓ) system. The silver (Ag) component is directly substituted with the noble metal to form a series of alloys. Addition of the noble metal increases the solidus and liquidus temperatures of the resulting air braze filler metals and increases temperatures under which seals and other sealing components formed from these filler metals can be employed.

### CROSS REFERENCE TO RELATED APPLICATION

This application claims priority from Provisional application No. 60/949,069 filed 11 Jul. 2007, incorporated herein in its entirety.

This invention was made with Government support under Contract DE-AC05-76RLO1830 awarded by the U.S. Department of Energy. The Government has certain rights in the invention.

### FIELD OF THE INVENTION

The present invention relates generally to ceramic-ceramic and ceramic-metal air-brazes and filler materials. More particularly, the invention relates to metal-metal oxide-metal alloys that have applications, e.g., as high temperature air brazes and/or filler metals.

### BACKGROUND OF THE INVENTION

Application of ceramics in critical high-temperature components has long been considered attractive because of the excellent mechanical properties, wear, and corrosion resistance of these materials at elevated temperatures. Their use, however, is often hindered by inability to economically manufacture large or complex shaped components that have reliable performance. A potential alternative to monolithic ceramic parts is the fabrication of smaller, simple-shaped pieces that can be assembled and joined, often with high-temperature metal components, to ultimately form larger, more complex structures. At issue is identifying a practical method of ceramic-ceramic or ceramic-metal joining. One of the most reliable methods of joining dissimilar materials is brazing, where a filler metal is heated whose liquidus temperature is well below that of the materials to be joined. Upon heating, the filler metal becomes molten and fills the gap between the two pieces to be joined under capillary action. Upon subsequent cooling, a solid joint forms. Addition of a reactive metal (e.g., Ti or Zr) is often required to bond ceramics (known as active metal brazing) at the joining interface. However, active metal brazes can be unreliable at temperatures above 500° C. because they can oxidize completely thereby conferring little or no strength to the joint. Air brazing is a new method of joining in which a predominantly metallic joint is formed in air without need of an inert cover gas or need for a surface reactive flux. The resulting bond has excellent strength and is inherently resistant to oxidation during high-temperature applications. The bond also offers long-term hermeticity (sealing capacity) at high temperatures when employed as a gas-tight or liquid-tight sealant. Air brazing typically employs a braze composition that when molten consists of an oxide dissolved in a noble metal filler. One noble metal-oxide combination that appears to be suited for air brazing is the Ag—CuOₓ system. However, in high-temperature devices—Solid Oxide Fuel Cells (SOFCs) being the most notable—an air braze that allows for long-term operation at temperatures in excess of 800° C. is desirable. At issue is how to modify the air braze filler metal so that these higher operational temperatures can be achieved. Accordingly, new compositions are needed that improve bonding in ceramic-ceramic and ceramic-metal components and increase operating temperatures in high-temperature devices and applications.

### SUMMARY OF THE INVENTION

In one aspect, the invention is a composition given by equation [1]:

[(100−y)[(100−z)M−(z)Ag]−(y)CuOₓ]] [1]

In this composition, (M) is a preselected noble metal that has a concentration of from 0 mol % to 100 mol %; y=0 mol % to 100 mol % CuOₓ, where x=0, 0.5, or 1 of copper (Cu) metal, Cu₂O, or CuO, respectively; and z=0 mol % to 100 mol % silver (Ag). Noble metals (M) suitable for use include, but are not limited to, e.g., gold (Au), palladium (Pd), platinum (Pt), rhodium (Rh), ruthenium (Ru), osmium (Os), rhenium (Re), and iridium (Ir), including mixtures of these metals. The invention finds application as an air braze filler metal alloy. Palladium is an exemplary metal component used herein to illustrate the invention, but is not intended to be limiting. The noble metal (M) can be added as a ternary component, e.g., to a mixture containing Ag and CuOₓ, or a like binary alloy system. Alternatively, the noble metal (M) can be mixed with Ag and Cu metals as, e.g., powders or foils, to obtain a ternary mixture of metals. Subsequent heating of the ternary metal mixture in air oxidizes the Cu metal in the mixture to the desired copper oxide (CuOₓ) component in the alloy. In these ternary systems, addition of the ternary metal (e.g., palladium) reduces silver content in the alloy, providing a series of potential alloys with the specified formula and composition. In the exemplary mixture, addition of palladium increases the solidus and liquidus temperatures of the resulting air braze and/or filler metal compositions. For example, liquidus temperature is greater by over 220° C. for the alloy composition of formula (100-y)(25Pd−75 Ag)−(y) CuOₓ as compared to binary Ag—CuOₓ alloys. The solidus temperature is greater in these alloy compositions by about 185° C. for values of (y) in the range from about 0 mol % to about 1 mol %, and 60° C. for values of (y) in the range from about 4 mol % to about 10 mol %. For alloy compositions of formula (100-y)(50 Pd—50Ag)−(y) CuOₓ, solidus temperature varies between about 380° C. to 390° C. greater than binary Ag—CuOₓ alloys when copper oxide in the composition ranges from 0 mol % to about 8 mol %.

In other embodiments involving alternate noble metals (e.g., Au or Rh), liquidus and/or solidus temperatures can be selectively adjusted based on the selected concentration of the noble metal in the composition. In the case of gold (Au), for example, with complete substitution of Ag in the composition with Au (i.e., unalloyed gold), the liquidus temperature can be increased by up to 110° C. over the unmodified Ag—CuOₓ alloy. Various increases in liquidus temperature up to the maximum increase can be achieved depending on the fraction of Ag that is substituted with Au in the composition. The magnitude of the increase will vary as a function of the level of Au substitution and can be estimated from the Ag—Au binary phase diagram. With rhodium (Rh) as the selected noble metal, complete substitution of Ag in the composition (i.e., unalloyed rhodium) provides an increase in liquidus temperature Lip to 1000° C. over the unmodified Ag—CuOₓ alloy (i.e., for a liquidus temperature as high as 1960° C.). Similarly, increase in solidus temperature can be up to 50° C. over the unmodified Ag—CuOₓ alloy in the case of unalloyed gold upwards to a solidus temperature as high as 1910° C. in the case of unalloyed rhodium. In short, liquidus and/or solidus temperatures can be selectively adjusted for intended applications, operating conditions, and devices depending on the selected concentration of the noble metal.

In another aspect, the invention is a seal or sealant for a high temperature device that includes a ternary M-Ag—CuOₓ alloy. The alloy includes a preselected concentration of a noble metal (M), (Ag) metal, and CuOₓ. The alloy has a chemical composition as follows: (100-y)[(100-z)M-(z)Ag]-(y)CuOₓ, where M=0 mol % to 100 mol % of a noble metal; y=0 mol % to 100 mol % CuOₓ; z=0 mol % to 100 mol % Ag; and x=0, 0.5, or 1 of Cu metal, Cu₂O, or CuO, respectively. Seals that include ternary M-Ag—CuOₓ alloy compositions of the invention have potential applications in, e.g., solid oxide fuel cells (SOFCs), SOFC components, sensors and sensor applications, seals and sealing components, gas concentrator devices, gas separator devices, and like applications and devices. No limitations are intended.

In another aspect, the invention is a method for making a seal that includes mixing a preselected concentration of a noble metal (M), Ag metal, and CuOₓ together to obtain a mixture that defines a ternary M-Ag—CuOₓ alloy of formula: (100-y)[(100-z)M-(z)Ag]-(y)CuOₓ. Here, M=0 mol % to 100 mol % of said noble metal; y=0 mol % to 100 mol % CuOₓ; z=0 mol % to 100 mol % Ag; and x=0, 0.5, or 1 of Cu metal, Cu₂O, or CuOₓ respectively. The mixture is melted to obtain a melt of the ternary M-Ag—CuOₓ alloy. And, the melt is solidified to form a seal that comprises the ternary M-Ag—CuOₓ alloy. The noble metal (M), Ag metal, and CuOₓ can be mixed, e.g., as separate elemental powders or foils or as compound alloy powders or foils to obtain the desired mixture. In various embodiments, mixing of the noble metal (M), Ag metal, and CuOₓ can be done, e.g., by mixing an Ag—CuOₓ alloy (e.g., as a powder or foil) to a noble metal (M) (e.g., as a powder or foil) to obtain the desired mixture. Or, an M-Ag metal alloy (e.g., as a powder or foil) can be mixed to CuOₓ to obtain the mixture. Or, an M-CuOₓ alloy (e.g., as a powder or foil) can be mixed with Ag metal (e.g., as a powder or foil) to obtain the mixture. The melt can be introduced to a mold or a die and solidified to form the seal with a preselected shape and thickness. In other applications, the melt can be introduced between components to be sealed and solidified to form the seal.

In another aspect, the invention is a method for making a seal that includes mixing a preselected concentration of a noble metal (M), Ag metal, and Cu metal together to obtain a mixture of same. The mixture is heated at a preselected temperature to oxidize Cu metal in the mixture to form a ternary M-Ag—CuOₓ alloy of formula: (100-y)[(100-z)M —(z)Ag]—(y)CuOₓ. Here, M=0 mol % to 100 mol % of said noble metal; where y=0 mol % to 100 mol % CuOₓ; z=0 mol % to 100 mol % Ag; and x=0, 0.5, or 1 of Cu metal, Cu₂O, or CuO, respectively. The mixture is then melted to obtain a melt of the ternary M-Ag—CuOₓ alloy. The melt is then solidified to form a seal that comprises the ternary M-Ag—CuOₓ alloy. The noble metal (M), Ag metal, and Cu metal can be mixed as separate components and/or as compound (e.g., binary) alloys (e.g., as powders or foils) to obtain the desired mixture. In various embodiments, mixing of the noble metal (M), Ag metal, and Cu metal can be done, e.g., by mixing an Ag—Cu alloy (e.g., as a powder or foil) to a noble (M) (e.g., as a powder or foil) to obtain the desired mixture. Or, an M-Ag metal alloy can be mixed with Cu metal (e.g., as a powder or foil) to obtain the mixture. Or, an M-Cu alloy can be mixed with Ag metal (e.g., as a powder or foil) to obtain the mixture. The melt can be introduced to a mold or a die and solidified to form the seal with a preselected shape and thickness. In other applications, the melt can be introduced between components to be sealed and solidified to form the seal. In another embodiment, the method includes the step of atomizing the mixture to form a powder that has a uniform composition prior to melting. A preselected quantity of a binder, a solvent, a plasticizer, and combinations of these constituents can be mixed with the powder to form a paste, a screen print ink, a paint, or a spray slurry that allows the mixture to be deposited to a joining surface. Binders including, e.g., wax binders; aromatic binders; polymer binders; and other binders, or combinations of these binders can be used. In other embodiments, the method includes the step of pressing the powder to form a preform of a preselected shape. Here, the step of pressing can include mixing a preselected quantity of a binder to the mixture that provides sufficient stability for handling and positioning the preform on a joining surface. The powder can be pressed using such processes as roll-pressing or casting methods. In one embodiment, the powder is pressed as a sheet preform that can be cut or machined to form a preselected geometry or shape that matches with a joining surface in the intended application or device.

In another aspect, the invention is a method for preparing a ternary M-Ag—CuOₓ alloy that includes: mixing a preselected concentration of a noble metal (M), Ag metal, and CuOₓ together to obtain a mixture that defines the ternary M-Ag—CuOₓ alloy with formula: (100-y)[(100-z)M-(z)Ag]—(y)CuOₓ. Here, M=0 mol % to 100 mol % of said noble metal; y=0 mol % to 100 mol % CuOₓ; z=0 mol % to 100 mol % Ag; and x=0, 0.5, or 1 of Cu metal, Cu₂O, or CuO, respectively. The ternary M-Ag—CuOₓ alloy is then atomized to form a powder of uniform composition.

In another aspect, the invention is also a method for preparing a ternary M-Ag—CuOₓ alloy that includes: mixing a preselected quantity of a noble metal (M), Ag metal, and Cu metal to obtain a mixture that defines a ternary M-Ag—Cu alloy. The mixture of M-Ag—Cu alloy is heated to oxidize Cu metal in mixture to form a ternary M-Ag—CuOₓ alloy of formula: (100-y)[(100-z)M-(z)Ag]−(y)CuOₓ. Here, M=0 mol % to 100 mol % of the noble metal; y=0 mol % to 100 mol % CuOₓ; z=0 mol % to 100 mol % Ag; and x=0, 0.5, or 1 of Cu metal, Cu₂O, or CuO, respectively. The mixture of the ternary M-Ag—CuOₓ alloy is then atomized to form a powder of uniform composition. These powder compositions can be used as high-temperature air braze filler metals.

### BRIEF DESCRIPTION OF THE DRAWINGS

FIGS. 1a-1b are plots showing liquidus and solidus temperatures, respectively, for exemplary ternary (Pd—Ag—CuOₓ) air braze filler metal compositions as a function of copper oxide content, according to an embodiment of the invention.

FIG. 2 is a plot showing liquidus and solidus temperatures in the Pd—Ag—CuOₓ system as a function of Pd concentration.

FIG. 3 is a plot that shows flexural strength of a joint made with a ternary (Pd—Ag—CuOₓ) air braze filler metal composition as a function of copper oxide content.

FIG. 4 is a schematic of a solid oxide fuel cell that includes one or more seals made with a ternary air braze filler metal composition, according to an embodiment of the invention.

FIG. 5 is a schematic of a gas concentrator device that includes one or more seals of various sizes made with a ternary air braze filler metal composition, according to another embodiment of the invention.

FIG. 6 is a schematic of a gas separator device that includes a seal composed of a ternary air braze filler metal composition of the invention, according to yet another embodiment of the invention.

### DETAILED DESCRIPTION

Described herein are novel air braze and/or filler metal compositions that include the binary components silver (Ag) and copper oxide (CuOₓ), and a ternary metal (M) that collectively define a series of M-Ag—CuOₓ ternary alloy compositions. It has been demonstrated that use temperatures in applications involving these compositions are extended by the presence of a ternary metal in the composition, e.g., a higher melting point noble metal. Metals (M) suitable for use in these ternary alloy compositions include, but are not limited to, e.g., gold (Au), palladium (Pd), platinum (Pt), rhodium (Rh), ruthenium (Ru), osmium (Os), rhenium (Re), iridium (Ir), and like noble metals, including alloys of these metals. These air braze filler metal compositions exhibit high melting point temperatures and can be employed over a wide range of operational temperatures. These compositions deliver excellent joint strength, are resistant to oxidation, and provide long-term hermeticity (sealing) during operation in high-temperature devices and in high-temperature applications.

These alloy compositions have uses: 1) as high-temperature air braze filler metals, and 2) as gap or joint filler materials used in hermetically sealing solid-state electrochemical devices and other high-temperature devices, including, but not limited to, e.g., solid-oxide fuel cells (SOFCs), gas separators, gas concentrators, and sensors. While the invention will be described in reference to palladium as a noble metal constituent, this metal element is exemplary only. The invention is not limited thereto. The effects of palladium content on liquidus and solidus temperatures of ternary metal-metal oxide-metal compositions are described as well as wetting characteristics of these materials on alumina substrates. The term “liquidus temperature” is the temperature at which a selected alloy composition is in a liquid state. The term “solidus temperature” is the temperature at which a selected alloy composition is in a solid state or transitions through a phase change to become a solid. Liquidus and solidus temperatures define a range of processing and maximum operating temperature over which the filler metal alloy composition can be employed to form a solid joint that will not re-melt during subsequent device fabrication steps or application. For example, in a 2-step brazing process, a 1^{st} filler metal composition can be dispensed or deposited as a 1^{st} brazing material and heated at a 1^{st} liquidus temperature and solidified at a 1^{st} solidus temperature to form a solid joint between multiple adjacent substrates or components. A 2^{nd} filler metal composition having a lower liquidus temperature can be dispensed or deposited subsequently to form a 2^{nd} brazed joint at temperatures that do not cause the first formed joint to re-melt and loosen and/or lose hermeticity or mechanical integrity. The solidus temperature can be identified in a differential thermal analysis (DTA) experiment as the temperature where the slope of the differential temperature or energy curve or a derivative of this curve first begins to deviate from baseline as an endothermic peak is traced. The liquidus temperature can be identified as the temperature at which an endothermic peak rejoins a baseline, or the temperature at which a derivative of a peak (e.g., a final peak) returns to baseline. Table 1 and Table 2 list Ag—Pd—CuO, filler metal compositions used in exemplary tests of the invention containing 25 mol % and 50 mol % Pd, respectively.

TABLE 1
Compositions of ternary Ag—Pd—CuOₓ alloys
(filler metals) containing 25 mol % Pd.

| Filler Metal | Ag (Mol %) | Pd (Mol %) | CuOₓ (Mol %) |
|---|---|---|---|
| 25PdAg—1CuO | 74.3 | 24.8 | 1 |
| 25PdAg—1.4CuO | 74.0 | 24.7 | 1.4 |
| 25PdAg—2CuO | 73.5 | 24.5 | 2 |
| 25PdAg—4CuO | 72.0 | 24.0 | 4 |
| 25PdAg—8CuO | 69.0 | 23.0 | 8 |
| 25PdAg—10CuO | 67.5 | 22.5 | 10 |
| 25PdAg—34CuO | 49.4 | 16.5 | 34.1 |

TABLE 2
Compositions of ternary Ag—Pd—CuOₓ alloys
(filler metals) containing 50 mol % Pd.

| Filler Metal | Ag (Mol %) | Pd (Mol %) | CuOₓ (Mol %) |
|---|---|---|---|
| 50PdAg—1CuO | 49.5 | 49.5 | 1 |
| 50PdAg—1.4CuO | 49.3 | 49.3 | 1.4 |
| 50PdAg—2CuO | 49 | 49 | 2 |
| 50PdAg—4CuO | 48 | 48 | 4 |
| 50PdAg—8CuO | 46 | 46 | 8 |
| 50PdAg—10CuO | 45 | 45 | 10 |
| 50PdAg—20CuO | 40 | 40 | 20 |
| 50PdAg—34CuO | 33 | 33 | 34 |

Short-hand notation of 25-Pd or 50-Pd is used herein to refer to these various series of filler metal compositions. In exemplary tests, palladium was added to silver in amounts ranging from 0 mol % to 50 mol % in increments of mol %. With the addition of copper oxide to form the ternary Pd—Ag—CuOₓ alloys, each composition is denoted by (100-y)[(100-z)Pd-(z)Ag]-(y)CuOₓ where y=0 mol % to 34 mol % CuOₓ and z=50 mol %, 75 mol %, and 100 mol % silver. While exemplary compositions are described herein for purposes of illustration, the invention is not limited thereto. As will be appreciated by those of skill in the art, many different ternary alloy compositions can be produced that fall within the specified formula ranges, as denoted herein. Thus, no limitations are intended.

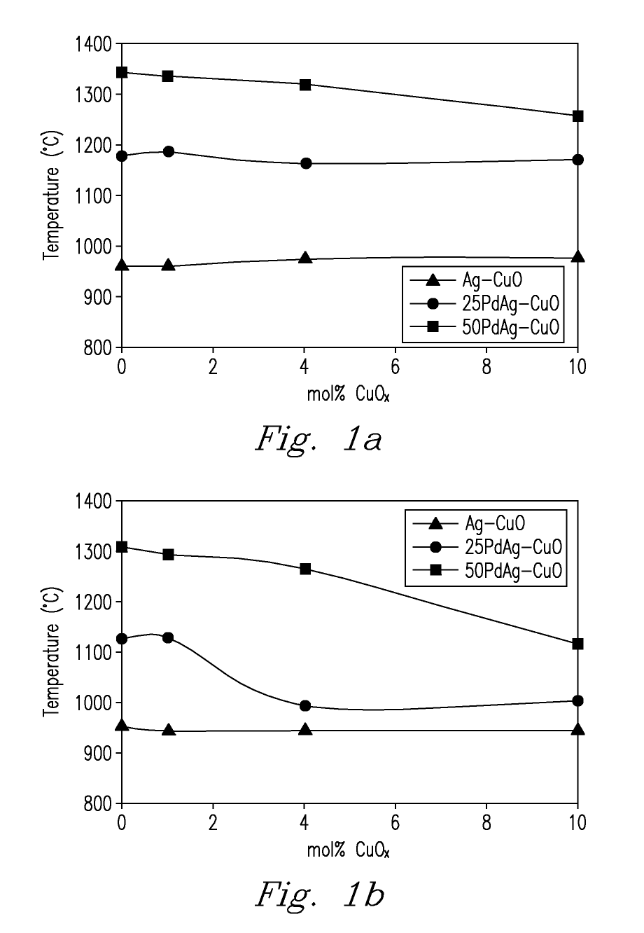

Copper metal powder can be used in the filler metal paste formulation and will oxidize during an air brazing operation. The resulting equilibrium copper oxide phase below the monotectic temperature of the Ag—CuOₓ system is CuO, which decomposes to form a mixture of CuO and Cu₂O above the monotectic temperature. Thus while target compositions listed in Table 1 assume an end composition of CuO, in reality, the final filler metal composition may contain Cu₂O depending on the temperature and duration of the brazing operation. The copper phase is generically referred to as CuOₓ, where x=0, 0.5, or 1 corresponds to metallic copper, ½Cu₂O, and CuO, respectively. Braze compositions were formulated by dry mixing appropriate amounts of silver powder (99.9%, 0.75 μm average particle size, copper powder (99%, 1.25 μm average particle size) and palladium powder (>99.9%, submicron average particles size) in a mortar and pestle. Copper was allowed to oxidize in situ as the mixture was heated in air. Phase changes can be identified in the various braze compositions as a function of temperature using, e.g., differential thermal analysis (DTA). The effect of palladium addition on liquidus and solidus temperatures of Pd—Ag—CuOₓ mixtures will now be discussed in reference to FIGS. 1a-1b.

FIGS. 1a-1b are plots showing liquidus temperatures in the Pd—Ag—CuOₓ system as a function of CuOₓ content, respectively. Effects of moderate-to-high palladium concentration (>5 mol %) on the solidus and liquidus temperatures in the Pd—Ag—CuOₓ system were studied using DTA. Some samples exhibit a number of endotherms with multiple peaks, each potentially corresponding to a phase change. In some cases, a broader endotherm is observed at higher temperature. Based on examinations of as-cooled microstructures for these samples, the results are attributed to formation of two-phase immiscible liquids. In the Ag—Pd binary system, solidus and liquidus temperatures both increase monotonically with increasing palladium content from the melting point of Ag at 962° C. to the melting point of Pd at 1555° C., although these two-phase lines display a slight negative deviation from ideal behavior. Although little is known of the Pd—CuO system, based on the melting point elevation effect of palladium on silver, solidus and liquidus lines were expected to increase with modest additions of palladium to the Ag—CuOₓ system, particularly at low copper oxide concentrations. As shown in FIG. 1a & FIG. 1b, this effect is observed in the ternary Pd—Ag—CuOₓ system. In both filler metal series, addition of palladium increases each characteristic temperature significantly above that found in the Ag—CuOₓ system. In general, the liquidus of the 25-Pd series of filler metal compositions is approximately 220° C. higher than for Ag—CuOₓ binary materials. For 50-Pd specimens, the increase in liquidus temperature ranges from 280° C. at 8 mol % CuOₓ to over 390° C. at near 0 mol % copper oxide. Similarly, solidus temperatures increase for 25 mol % Pd specimens by 185° C. for silver-rich filler metal compositions, and 60° C. for copper-rich compositions. In the 50-Pd series of filler metal compositions, the increase in solidus temperature varied from 390° C. to 170° C. over the compositional range of 0 mol % to 10 mol % CuOₓ.

FIG. 2 is a plot showing liquidus and solidus temperatures in the Pd—Ag—CuOₓ system as a function of Pd concentration. As shown in the figure, both liquidus and solidus temperatures increase with increasing concentration of palladium in ternary compositions of the invention. Based on this phenomena, a family of air braze filler metal compositions can be developed for use at operating temperatures above those possible for comparable Ag—CuOₓ filler metal compositions (i.e. where the binary filler metal would liquefy or undergo significant creep deformation).

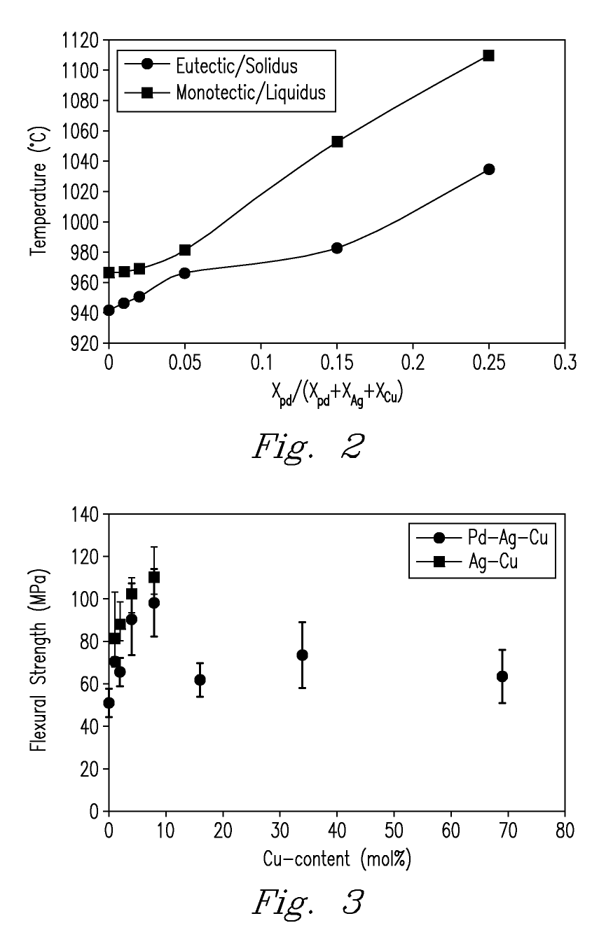

FIG. 3 is a plot showing average flexural strength of joints made with ternary (Pd—Ag—CuOₓ) compositions of the invention as a function of increasing (CuO) content. Tests with these compositions employed a fixed palladium (Pd) concentration of 15 Mol %, but the invention is not limited thereto. The Pd—Ag—CuO filler metal compositions were used to join yttrium-stabilized zirconia (YSZ) bend bar specimens. In the figure, joint strength increases to a maximum of about 110 MPa at a (CuO) concentration of between about 4 Mol % and 8 Mol %, decreasing in a general parabolic trend thereafter. The strength of a joint can be optimized based on concentrations of the constituents in the selected filler metal composition. The balance between wettability and adhesion in the joint improves with increasing CuO content, which contributes to the overall joint strength. Various flexural strengths are obtained based on the preselected (Cu) concentration. Suitable flexural strengths can thus be selected for given applications or particular use temperatures. While exemplary component concentrations in the compositions have been demonstrated here, the invention is not limited thereto.

### High-Temperature Devices and Applications

Designing and fabricating high-temperature gradient-based electrochemical devices such as planar solid oxide fuel cells (pSOFC) requires sealing adjacent metal and ceramic components, e.g., in conjunction with seals and/or sealing components. Compositions of the invention described herein are suitable for use as seals or sealing components in high-temperature devices. Sealants made with these ternary alloy compositions of the invention are also suitable for sealing device components. Seals, sealing components, and preforms containing ternary alloy compositions of the invention can be fabricated with desired shapes and thicknesses using various casting methods known in the mechanical arts including, but not limited to, e.g., tape casting, paste casting, dispense paste casting, sand casting, mold casting, shell mold casting, metal casting, die casting, spin casting, lost wax casting, centrifugal casting, foil casting, continuous casting, roll casting, and like casting methods. Seals, sealing components, and preforms containing ternary alloy compositions of the invention can be further fabricated using roll-pressing and other pressing methods known to those of skill in the art. Ternary alloy compositions of the invention may be further applied as sealants and air braze filler materials in high-temperature devices in conjunction with processes including, but not limited to, e.g., screen printing, preforming methods, air brazing methods, multi-step brazing methods, and like processes known in the manufacturing arts. In such applications, compositions of the invention can be mixed with such constituents as binders, solvents, plasticizers, and mixtures of these constituents to form pastes, screen print inks, paints, and spray slurries that allow the compositions to be deposited on a joining surface. Sealing of device components, e.g., can be done using air brazing processes as described, e.g., by Weil et al. (in “Reactive Air Brazing: a novel method of sealing SOFCs and other solid-state electrochemical devices”, Electrochem. So. St. Lett. 8 (2): A133-A136), which reference is incorporated herein in its entirety. Sealing in exemplary high-temperature devices will now be described.

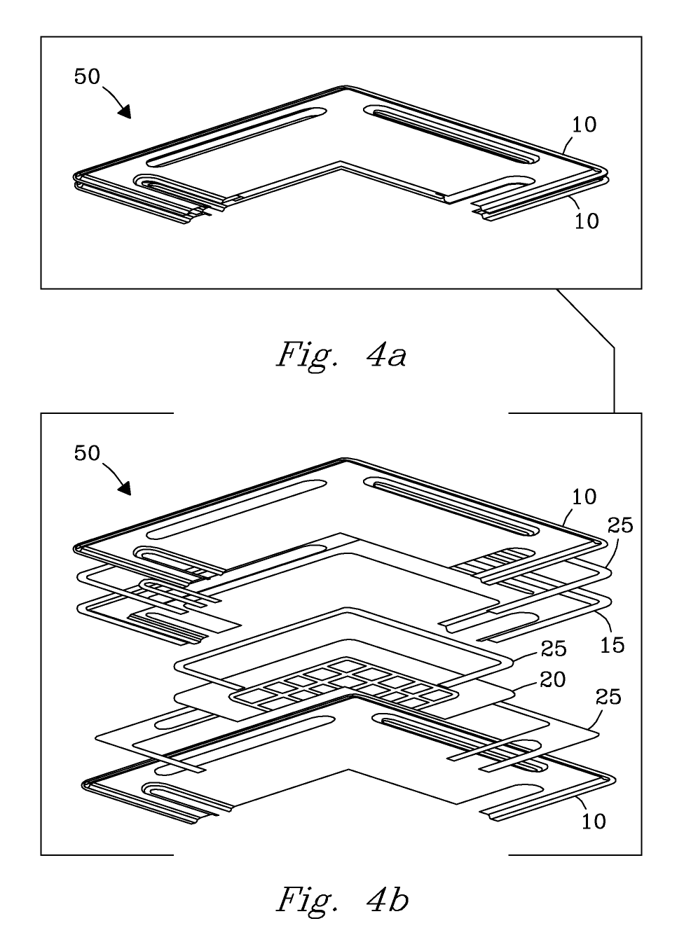

FIG. 4a illustrates a single cassette 50 (unit) of an exemplary solid oxide fuel (SOFC) stack (stack not shown). The cassette is bounded top and bottom by an interconnect plate 10. An exploded view of the cassette is shown in FIG. 4b. In the illustrated design, a separator (interconnect) plate 10, a window frame 15, and a ceramic cell 20 form the unit or cassette that is repeated throughout the SOFC stack. The window frame provides a reliable means of manifolding gas within and through the stack, and establishes a uniform gap that provides air Flow across an SOFC cathode (not shown). In the figure, three seals 25 are illustrated. A first seal 25 is positioned between a top interconnect plate 10 and window frame 15. A second seal 25 is positioned on top of ceramic cell 20, sealing the ceramic cell to window frame 15. A third seal 25 is positioned between window frame 15 and a (bottom) interconnect plate 10 of the cassette. Each seal in the SOFC stack is composed of a suitable ternary air braze filler metal composition defined by equation [1], which is preselected for a particular device, application, and/or operation temperature. While three seals are illustrated in the present design, number is not limited. Seals and sealing components in these stack assemblies can be expected to be exposed to both oxidizing and reducing atmospheres or environments at routine operating temperatures of between, e.g., 650° C. and 800° C., although temperatures are not limited thereto. Under the selected operating conditions, seals and sealing components in the stack must retain their hermeticity (sealing capacity), mechanical ruggedness, and chemical stability through numerous thermal cycles and over the lifetime of the device, which lifetimes can extend beyond 25,000 hours. One of the complications in fabricating a multi-component device is that a sequential series of joining and/or sealing steps is often required. Subsequent joining or sealing steps can re-expose an original seal to a temperature that can potentially compromise the original seal. Seal 25 positioned, e.g., between top interconnect plate 10 and window frame 15 preferably has a sufficiently high solidus temperature that it will not re-melt or lose integrity at the temperature employed in a subsequent stack sealing step. Introduction of a melting point elevator such as palladium in a ternary filler metal composition (e.g., Pd—Ag-4CuO) can raise the solidus temperature of the alloy by as much as, e.g., 50° C. to 100° C., and further provides a suitable joint strength for operation. By selecting a suitable ternary filler metal composition (e.g., as described previously in reference to FIG. 2), air braze sealing can be reliably performed at temperatures as low as 970° C. Selection of different filler metal compositions with suitable solidus temperatures can allow air brazing to be employed for any seal in a sealing operation. Air brazing using ternary compositions of the invention permits SOFC seals and ceramic components to be joined directly in air and forms a hermetic seal that is resistant to oxidation. Sealing under these conditions is preferably done with ternary filler metal compositions that have little effect 1) on the wetting behavior of these compositions during the air brazing process that joins the component pieces or 2) on the strength of the resulting joints.

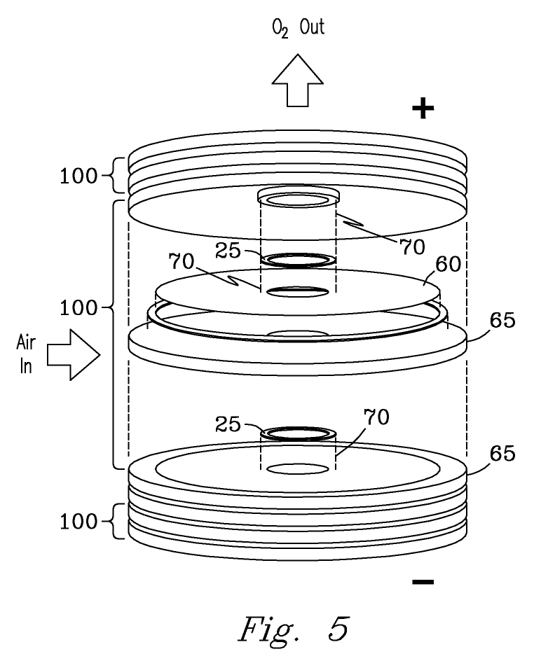

FIG. 5 is a schematic of a gas concentrator device that includes one or more seals 25 of preselected sizes. Seals 25 are composed of ternary air braze filler metal compositions described herein. In this design, a suitable ceramic electrolyte membrane 60 containing suitable electrodes and electrical connections is hermetically joined at seals 25 to adjacent metallic separator plates 65 that yield a unit 100 that is repeated throughout in forming a multiple membrane stack. The seals can be formed by using any variety of ternary filler metal compositions defined by equation [1]. Air enters the stack through a series of manifold holes (not shown) in each separator plate 65 and passes over one side (e.g., the cathode side) of each electrolyte membrane 60. Oxygen in the air is catalytically ionized and ionically transported across the membrane under an electric field and/or chemical gradient, and after reduction on the anode, forms a stream of purified oxygen that can be collected through a second set of manifold holes (not shown) in each separator plate near the central chimney 70 of the stack. The purified oxygen then flows up chimney 70 for application downstream of the device. The hermeticity of the seals is important in ensuring high separation efficiency and delivering a high purity oxygen stream.

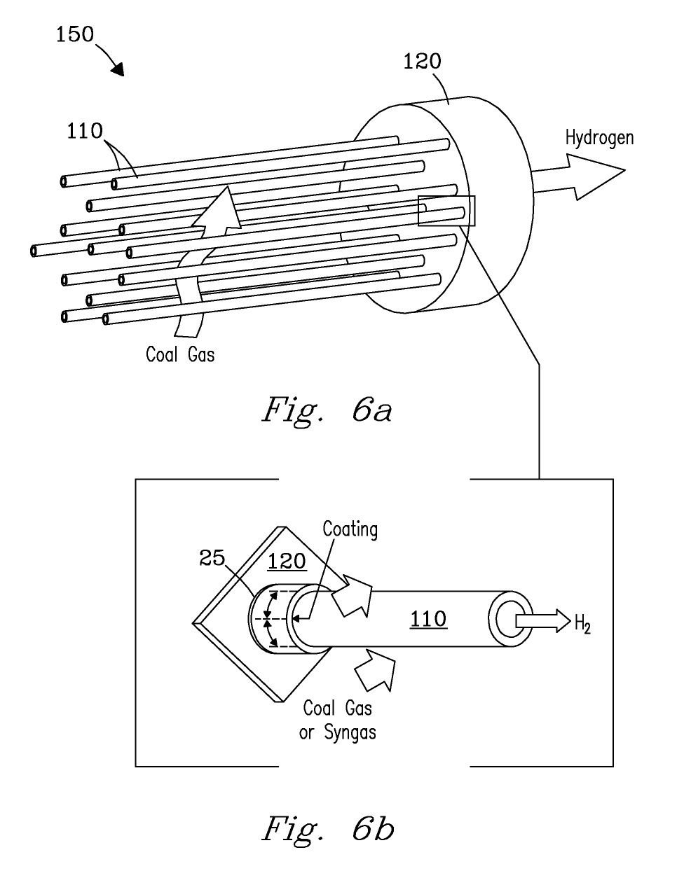

FIG. 6a illustrates a single unit 150 of an exemplary gas separator device that includes a bank of gas separator tubes 110 that each couple to gas manifold 120. A single separator tube is illustrated in FIG. 6b. In this design, a suitable tubular membrane 110 is hermetically joined with seals 25 to adjacent metallic or ceramic gas manifolds 120 at either end of the tube (one of which is shown). Each portion of the tube that inserts into the manifold includes a coating of a ternary air braze filler metal of the invention. Membrane 110 can be nanoporous or can be composed of mixed conducting (ionic and electronic) ceramic electrolytes to carry out selected transport of a single given chemical species. A bank of tubes is joined in this way to form a separation unit (see FIG. 6a). As shown in the figure, a mixture of gases (coal gas being an example, which is composed of a majority of H₂, CO, H₂O, and CO₂ gases) is passed over the bank of tubular membranes. By physical separation (i.e. through pores small enough to allow transport of only the smallest gas species) or electrochemical separation (i.e. under an electrical field and/or chemical gradient), one gas species is preferentially transported from one side of the membrane to the other. For example, hydrogen can be preferentially transported from the outside of the tubes to the inside where it collects and eventually flows to a manifold 120 system for transport to an application downstream of the device. The hermeticity of the seals is important in ensuring high separation efficiency and delivery of a high purity product stream. The seals can be formed using any variety of ternary filler metal compositions defined by equation [1].

The following examples provide a further understanding of the invention in its broader aspects.

### EXAMPLE 1

### DTA Analysis of Pd—Ag—CuOₓ Ternary Alloys

Thermal analysis of Pd—Ag—CuOₓ ternary alloy compositions was conducted using a DTA system equipped with a high-temperature furnace and a Type-S sample carrier. Samples were prepared by cold pressing approximately 5-10 mg of a given powder mixture into a 2 mm diameter pellet. DTA experiments were performed in dry air flowing at a rate of 10 mL/min. A heating rate of 10° C./min was employed, with maximum temperature based on the palladium content of the sample under consideration. Binary alloy samples (controls) were heated to a maximum temperature of 1000° C. Ternary 25-Pd alloy samples were heated to 1250° C.; 50-Pd samples were heated to 1400° C. Each sample was analyzed three times to ensure good reproducibility in results. Measurement of solidus and liquidus temperatures as a function of alloy composition from 0 to 50 mol % Pd in Ag differed by less than 1%.

### EXAMPLE 2

### Wettability of Pd—Ag—CuOₓ Filler Materials

Wettability of ternary Pd—Ag—CuOₓ ternary alloy compositions was determined using a standard sessile drop technique, e.g., as detailed by Humpston et al. in “Principles of Soldering and Brazing” (ASM International, Materials Park, Ohio, 1993) and Eustathopoulos et al. in “Wettability at High Temperatures” (Pergamon, Amsterdam, New York, 1999), and reported (J. T. Darsell and K. S. Weil, “The effect of palladium additions on the solidus/liquidus temperatures and wetting properties of Ag—CuO based air brazes,” J. Alloy Comp., 433 (1-2) (2007), 184-92). Sessile drop experiments were conducted in a static air muffle furnace outfitted with a quartz window through which the contact angle (θ, degrees) of heated specimens could be recorded. Pellets [˜7 mm diameter×10 mm thick] of the selected alloy were cold-pressed on a polished face of a polycrystalline alumina substrate, (99.7% α-Al₂O₃; 50 mm diameter×6 mm thick discs)] and heated using a schedule that was dependent on the palladium content of the composition under consideration. For 25-Pd samples, the furnace was heated at 30° C./min to an initial temperature of 1100° C., followed by heating at 10° C./min with an equilibration time of 15 minutes at each of 1150° C., 1200° C., and 1250° C. The same heating cycle was employed for 50-Pd samples, with the addition of two 15 minute equilibration times at 1300° C. and 1350° C. A high speed video camera equipped with a zoom lens was used to record the profile of the braze pellets throughout the heating cycle. Contact angles between the air braze and alumina substrate were measured from digital still images and correlated with temperature logs for heating runs. Data are presented in TABLES 3-5.

TABLE 3
Contact angles measured for Ag—CuOₓ alloys (controls).
Ag—CuOx

| | | Contact Angle | |
|---|---|---|---|
| Mol % Cu | Mol % Ag | (θ, degrees) | Temp (° C.) |
| 80 | 20 | 5.6 | 1100 |
| 69 | 31 | 4.2 | 1100 |
| 60 | 40 | 9.0 | 1100 |
| 60 | 40 | 9.9 | 1100 |
| 50 | 50 | 14.2 | 1100 |
| 40 | 60 | 15.7 | 1100 |
| 30 | 70 | 17.1 | 1100 |
| 20 | 80 | 22.4 | 1100 |
| 10 | 90 | 30.4 | 1100 |
| 8 | 92 | 37.6 | 1100 |
| 4 | 96 | 44.3 | 1100 |
| 2 | 98 | 48.6 | 1100 |
| 1 | 99 | 53.6 | 1100 |
| 1 | 99 | 59.5 | 1100 |
| 1 | 99 | 74.9 | 1100 |

TABLE 4
Contact angles measured for ternary (25-Pd) Pd—Ag—CuOₓ alloys.
25 mole % Pd to 75 mole % Ag
(25Pd—75Ag—CuOₓ)

| | Mol % Metals to | Contact Angle | Temp (° C.) |
|---|---|---|---|
| Mol % Cu | CuOₓ | (θ, degrees) | (15 min. hold) |
| 34 | 66 | 24.1 | 1250 |
| 10 | 90 | 39.9 | 1250 |
| 8 | 92 | 49.0 | 1250 |
| 4 | 96 | 64.8 | 1250 |
| 2 | 98 | 75.6 | 1250 |
| 1.4 | 98.6 | 78.3 | 1250 |
| 1 | 99 | 78.3 | 1250 |

TABLE 5
Contact angles measured for ternary (50-Pd) Pd—Ag—CuOₓ alloys.
50 mole % Pd to 50 mole % Ag
(50Pd—50Ag—CuOₓ)

| | Mol % Metals to | Contact Angle | Temp (° C.) |
|---|---|---|---|
| Mol % Cu | CuOₓ | (θ, degrees) | (15 min. hold) |
| 34 | 66 | 32.7 | 1200 |
| 34 | 66 | 30.5 | 1250 |
| 34 | 66 | 29.9 | 1300 |
| 34 | 66 | 28.5 | 1350 |
| 34 | 66 | 28.5 | 1350 |
| 20 | 80 | 48.5 | 1350 |
| 10 | 90 | 90.0 | 1350 |
| 8 | 92 | 98.8 | 1350 |
| 4 | 96 | 104.7 | 1350 |
| 4 | 96 | 106.4 | 1350 |
| 2 | 98 | 106.2 | 1350 |
| 1.4 | 99 | 106.8 | 1350 |
| 1 | 99 | 106.6 | 1350 |

### EXAMPLE 3

### Joint Strength Measurements

Joint strength measurements were conducted by four point bend strength tests. Test specimens were prepared from ˜5.5 mm thick rectangular YSZ plates fabricated from YSZ compacts by uniaxially pressing YSZ powder in dies at 25 MPa, isostatic densification of the YSZ compacts at 135 MPa, and sintering the compacts at 1450 C for 1 h to form dense plates. After sintering, one edge of each plate was polished to a −3 μm finish that gave a flat faying surface. A 70 wt % filler metal braze paste mixed with a polymer binder was screen printed onto the surface. Two plates were mated along the printed edges and fixed using steel clips. Shims were placed at ends of the joint to maintain a uniform gap thickness for subsequent bend testing. The assembly was brazed in air at 1150° C. for 30 minutes. Resulting 64 mm square plates were ground to a 4 mm thickness and cut into bend specimens 3 mm wide. A flexural load was applied at a head rate of 0.5 mm/min up to a point of failure which were recorded.

### CONCLUSIONS

Ternary alloy compositions based on an M-Ag—CuOₓ system have been described that find use, e.g., as high-temperature air braze filler materials, in hermetic seals and sealing components for sealing applications, in solid-state electrochemical devices and other high temperature devices, including, but not limited to, e.g., solid-oxide fuel cells (SOFCs), gas separators, gas concentrators, and sensors. Addition of a small amount of CuOₓ improves wetting characteristics of the alloy compositions, e.g., the 15PdAg alloys relative to, e.g., YSZ substrates, and thereby forms joints with preselected and suitable strength. In particular, addition of approximately 4 mol % to 8 mol % CuO to a 15Pd—Ag alloy provides optimal flexural strength, on the order of 90 MPa. This CuO concentration range promotes formation of a continuous and sufficient CuO interfacial layer between joining substrates that achieves optimal joint strength. Brazing with these filler metal compositions can be effectively conducted at temperatures up to about 1075° C. In addition, compositions of the invention are compatible with other air braze filler metals, e.g., binary filler metals. When a noble metal such as palladium is added to a Ag—CuOₓ air braze system, use temperatures of the resultant braze filler metals and materials increase. For example, palladium increases both the liquidus and solidus temperatures by as much as 350° C. over binary compositions known in the art. Temperature increase for compositions with higher CuOₓ content is less dramatic, but such compositions also provide a range of acceptable air braze materials with a broad range of application temperatures. Addition of palladium also increases the wetting angle between the air braze filler metals and, e.g., alumina substrates. Compositions of (100-x)(25Pd-75Ag)−(x) CuOₓ display satisfactory wetting at all CuOₓ contents investigated. Filler metals of the (100-x)(50Pd-50Ag)−(x) CuOₓ series do not effectively wet alumina if CuOₓ concentrations are less than about 10 mol %. The ternary systems described herein have potential uses as high-temperature air braze materials, and exhibit higher temperature capability over Ag—CuOₓ systems known in the art. Addition of such wetting agents as TiO₂ improves wetting behavior, adhesion, and joint strength in air braze filler metals (alloys) modified with noble metals. While exemplary embodiments of the present invention have been shown and described, it will be apparent to those skilled in the art that many changes and modifications may be made without departing from the invention in its true scope and broader aspects. The appended claims are therefore intended to cover all such changes and modifications as fall within the spirit and scope of the invention.

We claim:

1. A seal, characterized by:
a ternary M-Ag—CuOₓ alloy comprised of a preselected concentration of a noble metal (M), (Ag) metal, and CuOₓ, said alloy has chemical composition:
(100-y)[(100-z)M-(z)Ag]-(y)CuOₓ;
where M=0 mol % to 100 mol % of said noble metal;
where y=0 mol % to 100 mol % CuOₓ;
z=0 mol % to 100 mol % Ag; and
x=0, 0.5, or 1 of Cu metal, Cu₂O, or CuO, respectively.

2. The seal of claim 1, wherein said noble metal (M) is selected from the group consisting of: gold (Au); palladium (Pd); platinum (Pt); rhodium (Rh); ruthenium (Ru); osmium (Os); rhenium (Re); iridium (Ir); and combinations thereof.

3. The seal of claim 1, wherein said seal is a component of a solid oxide fuel cell, a gas concentrator device, or a gas separator device.

4. A method for making a seal, comprising the steps of:
mixing a preselected concentration of a noble metal (M), Ag metal, and CuOₓ together to obtain a mixture that defines a ternary M-Ag—CuOₓ alloy of formula:
(100-y)[(100-z)M-(z)Ag]-(y)CuOₓ;
where M=0 mol % to 100 mmol % of said noble metal;
where y=0 mol % to 100 mol % CuOₓ;
z=0 mol % to 100 mol % Ag; and
x=0, 0.5, or 1 of Cu metal, Cu₂O, or CuO, respectively;
melting said mixture to obtain a homogeneous melt of said ternary M-Ag—CuOₓ alloy; and
solidifying said melt to form a seal that comprises said ternary M-Ag—CuOₓ alloy.

5. The method of claim 4, wherein the step of mixing said noble metal (M), said Ag metal, and said CuOₓ includes mixing individual components to obtain said mixture.

6. The method of claim 5, wherein the step of mixing said noble metal (M), said Ag metal, and said CuOₓ includes mixing: a) an Ag—CuOₓ alloy to a noble metal (M) to obtain said mixture, or b) an M-Ag metal alloy to CuOₓ to obtain said mixture, or c) an M-CuOₓ alloy to Ag metal to obtain said mixture.

7. The method of claim 5, wherein the step of solidifying includes use of a mold whereby said seal obtains a preselected shape and thickness.

8. The method of claim 5, wherein the step of solidifying includes solidifying said melt between components of a high-temperature device whereby said seal forms between said components of said device sealing same.

9. A method for making a seal, comprising the steps of:
mixing a preselected concentration of a noble metal (M), Ag metal, and Cu metal together to obtain a mixture of same;
heating said mixture at a preselected temperature to oxidize Cu metal in said mixture to form a ternary M-Ag—CuOₓ alloy of formula:
(100-y)[(100-z)M-(z)Ag]-(y)CuOₓ;
where M=0 mmol % to 100 mol % of said noble metal;
where y=0 mol % to 100 mol % CuOₓ;
z=0 mol % to 100 mol % Ag; and
x=0, 0.5, or 1 of Cu metal, Cu₂O, or CuO, respectively;
melting said mixture to obtain a homogeneous melt of said ternary M-Ag—CuOₓ alloy; and
solidifying said melt to form a seal that comprises said ternary M-Ag—CuOₓ alloy.

10. The method of claim 9, wherein the step of mixing said noble metal (M), said Ag metal, and said Cu metal includes mixing same as individual components to obtain said mixture.

11. The method of claim 10, wherein the step of mixing said noble metal (M), said Ag metal, and said Cu metal includes mixing: a) an Ag—Cu alloy to a noble metal (M) to obtain said mixture, or b) an M-Ag metal alloy to Cu metal to obtain said mixture, or c) an M-Cu alloy to Ag metal to obtain said mixture.

12. The method of claim 9, wherein the step of solidifying includes use of a mold whereby said seal obtains a preselected shape and thickness.

13. The method of claim 9, wherein the step of solidifying includes solidifying said melt between components of a high-temperature device whereby said seal forms between said components of said device sealing same.

14. The method of claim 9, further comprising the step of atomizing said mixture to form a powder of uniform composition prior to melting.

15. The method of claim 14, further comprising the step of mixing a preselected quantity of a constituent selected from the group consisting of: a binder, a solvent, a plasticizer, and combinations thereof to said powder to form a paste, a screen print ink, a paint, or a spray slurry that allows said mixture to be deposited to a joining surface.

16. The method of claim 14, further comprising the step of pressing said powder to form a preform of a preselected shape.

17. The method of claim 16, wherein the step of pressing said powder includes mixing a preselected quantity of a binder to said mixture that provides sufficient stability for handling, delivering, or positioning said preform on a joining surface.

18. The method of claim 16, wherein the step of pressing said powder includes roll-pressing or casting said powder to provide a sheet preform, said sheet preform can be cut or machined to achieve a preselected geometry or shape that matches a joining surface for application thereon.

19. A composition, comprising:
a preselected concentration of a noble metal (M), Ag, and CuOₓ that defines a ternary M-Ag—CuOₓ alloy of formula:
(100-y)[(100-z)M-(z)Ag]-(y)CuOₓ;
where M=0 mol % to 100 mol % of said noble metal;
where y=0 mol % to 100 mol % CuOₓ;
where z=0 mol % to 100 mol % Ag; and
where x=0, 0.5, or 1 of Cu metal, Cu₂O, or CuO, respectively.

20. The composition of claim 19, wherein said noble metal (M) is selected from the group consisting of: gold (Au); palladium (Pd); platinum (Pt); rhodium (Rh); ruthenium (Ru); osmium (Os); rhenium (Re); iridium (Ir); and combinations thereof.

21. The composition of claim 19, wherein said M-Ag—CuOₓ composition is a constituent of an air braze filler material.

22. The composition of claim 19, wherein said M-Ag—CuOₓ composition is a component of a sealant.

23. The composition of claim 19, wherein said M-Ag—CuOₓ composition is a constituent of a seal or sealing device.

24. A method of preparing a ternary M-Ag—CuOₓ alloy, comprising the steps:
mixing a preselected concentration of a noble metal (M), Ag metal, and CuOₓ together to obtain a mixture that defines a ternary M-Ag—CuOₓ alloy of formula:
(100-y)[(100-z)M-(z)Ag]-(y)CuOₓ;
where M=0 mol % to 100 mol % of said noble metal;
where y=0 mol % to 100 mol % CuOₓ;
z=0 mol % to 100 mol % Ag; and
x=0, 0.5, or 1 of Cu metal, Cu₂O, or CuO, respectively;
atomizing said mixture to form a powder of uniform composition of said ternary M-Ag—CuOₓ alloy.

25. A method of preparing a ternary M-Ag—CuOₓ alloy, comprising the steps:
mixing a preselected quantity of a noble metal (M), Ag metal, and Cu metal to obtain a mixture that defines a ternary alloy;
heating said mixture at a preselected temperature to oxidize Cu metal in said mixture to form a ternary M-Ag—CuOₓ alloy of formula:
(100-y)[(100-z)M-(z)Ag]-(y)CuOₓ;
where M=0 mol % to 100 mol % of said noble metal;
where y=0 mol % to 100 mol % CuOₓ;
where z=0 mol % to 100 mol % Ag; and
where x=0, 0.5, or 1 of Cu metal, Cu₂O, or CuO, respectively; and
atomizing said mixture to form a powder of uniform composition of said ternary M-Ag—CuOₓ alloy.
